(19) United States
(12) Patent Application Publication
(10) Pub. No.: US 2024/0363920 A1
(43) Pub. Date: Oct. 31, 2024

(54) THERMALLY CONTROLLED ELECTRICAL ENERGY STORAGE DEVICE AND ASSOCIATED VEHICLE

(71) Applicant: Dana Canada Corporation, Oakville (CA)

(72) Inventor: Fabrice CHOPARD, Saint-Martin-d'Hères (FR)

(21) Appl. No.: 18/611,529

(22) Filed: Mar. 20, 2024

(30) Foreign Application Priority Data
Apr. 30, 2023 (FR) 2304370
May 31, 2023 (FR) 2305460

(51) Int. Cl. H01M 10/6556; H01M 10/613; H01M 10/625; H01M 10/647

(52) U.S. Cl. CPC H01M 10/6556; H01M 10/613; H01M 10/625; H01M 10/647; H01M 2220/20

(57) ABSTRACT

The present disclosure relates to a thermally controlled electrical energy storage device, comprising a plurality of electrical cells having at least three sides, a wafer, a cathode and an anode located on one or both sides. The device comprises a first heat exchange device comprising a heat pipe in heat exchange with the cells and a cold source of at least one second heat exchange device, the heat pipe having a body incorporating channels containing a heat-carrying substance and presenting a vaporization portion of the heat-carrying substance, a condensation portion located higher than the vaporization portion, and a curved portion between the vaporization portion and the condensation portion. The edge of each cell is located along the vaporization and condensation portions of the channels, with the cathode and/or anode of each cell facing the vaporization or condensation portion of the channels.

### CROSS-REFERENCE TO RELATED APPLICATION

The present application claims priority to French Patent Application No. 2304370, entitled “THERMALLY CONTROLLED ELECTRICAL ENERGY STORAGE DEVICE AND ASSOCIATED VEHICLE”, filed Apr. 30, 2023, and French Patent Application No. 2305460, entitled “THERMALLY CONTROLLED ELECTRICAL ENERGY STORAGE DEVICE AND ASSOCIATED VEHICLE”, and filed on May 31, 2023. The entire contents of each of the above-identified applications are hereby incorporated by reference for all purposes.

### TECHNICAL FIELD

The technical field concerned is that of the thermal control of electrical energy storage devices in chemical form for a vehicle, in other words electric accumulators.

### BACKGROUND AND SUMMARY

As is well known, an electric battery is a set of electrical accumulators linked together to create an electrical generator of desired voltage and capacity. These accumulators are often referred to as battery cells. Such a battery, and hence these accumulators or cells, enables electrical energy to be stored in chemical form and released in the form of direct current, in a controlled manner.

Already known are thermally controlled devices comprising an electric battery, itself comprising a plurality of electric cells arranged parallel to one another along a line, each cell having a first side, a second side and a third side, the second side and the third side being parallel to one another and transverse to the first side.

The disadvantages of batteries include:
their high costs,
their autonomy,
their charging time,
the difficulty of controlling the temperature they reach, especially in hot conditions “(ultra) fast charge”.

To be able to cool, or more generally to thermally control one or more cells, not only requires the presence of certain heat exchange means such as a heat pipe capable of heat exchange with the cells (forming a hot source) and a cold source, but the position of certain parts of these elements in relation to certain parts of the cells is also important.

This is because not all zones or parts of a cell vary in temperature in the same way, especially under (ultra) fast load conditions.)

It is therefore proposed that the thermally controlled device presented above comprise, in addition to the above, a first heat exchange device comprising a heat pipe capable of heat exchange with the cells and a cold source of at least one second heat exchange device, the heat pipe being defined by a one-piece body internally integrating a series of channels arranged side by side, and containing a heat-carrying substance. The channels have at least one vaporization section where the heat-carrying substance can be heated, until vaporized, by calories from at least one of the cells, and a condensation section where the heat-carrying substance can be cooled, until condensed, by heat exchange with the cold source of the second heat exchange device. The body is angled, so that the channels each have at least one curved portion located between the at least one vaporization portion and the condensation portion.

The heat pipe is arranged so that:
the edge of each cell is located along the vaporization part and the condensation part of the channels of the monoblock body,
the cathode terminal and/or the anode terminal of each cell are located opposite the vaporization part or the condensation part of the channels of the monoblock body; and
the condensation section is located at a higher elevation than the vaporization section with respect to gravity.

For instance, the heat pipe is gravitational, in the sense that the internal geometry of the channels ensures that the return of the heat-carrying substance from the condensation part to the vaporization part takes place by gravity, as opposed to capillary heat pipes where fluid displacement takes place by capillarity thanks to a porous material, or wick, present in the heat pipe channels.

The gravity heat pipes may be used in the present disclosure can be of several types of operating mode: flooded, thermosyphon or pulsed. The arrangement according to the present disclosure may offer efficient thermal performance with gravity heat pipes having a hybrid mode of operation between thermosyphon and pulsed. This hybrid operation means that a succession of vapour pockets separated by liquid will circulate by gravity difference from the evaporation zone to the condensation zone. In pure thermosyphon mode, the bubbles gather in the center of the channel, until only steam rises to the condensation zone.

This succession of steam pockets ensures optimum heat exchange efficiency.

As a reminder, and as provided here, on a heat pipe, vaporization of a liquid enables a large amount of energy to be absorbed efficiently. Heat pipes are, or contain, thermally conductive tubes or channels, often made of metal, used to transport heat using the principle of transfer by phase transitions (also known as phase change). The channels are enclosed in the “body”, which forms a closed (hermetically sealed) monoblock enclosure around them. The channels are arranged in parallel.

The heat pipe(s) in question do not require a pumping element (porous body, pump, etc.) to operate. They are therefore closed, leak-tight devices containing a heat-carrying substance, e.g. for the whole of the present presentation, a phase-change fluid, in liquid phase at the condensation temperature useful for the field concerned, in equilibrium with its vapor phase at the vaporization temperature useful for the field concerned, the movement of the heat-carrying substance being generated by a difference of state and not by a pumping element.

The heat-carrying, two-phase substance (also called working fluid), which can evaporate and condense, may be chosen according to the application and the operating temperatures. It can be water or, for example, for the automotive sector, R-1233ZD (E) (trans-1-Chloro-3,3,3-trifluoropropene), R290 (propane gas), or NOVEC™ 649 from 3M.

The heat transfer medium is loaded into the heat pipes in a conventional manner.

In the first part of the heat pipe, e.g. the channels (cf. the “vaporization section” or evaporator), the liquid is heated by an external source (“the cells”) in thermal contact with the evaporator. The liquid evaporates until it reaches a second part of the heat pipe (cf. the “condensation section” or condenser), where the vapor is condensed. The condenser is in thermal contact with an element (the “cold source”) that removes the heat transported by the heat pipe from the evaporator. The condensate then returns to the evaporator, by gravity. The liquid then undergoes further evaporation/condensation cycles, removing heat from the cells to the cold source.

At the communication junction between the vaporizing and condensing sections lies the adiabatic intermediate zone. For the heat pipe to operate by gravity, the channels enclosed in the sealed body stand upright, with the condensing section located at a higher elevation than the vaporizing section in relation to gravity.

In these conditions, the expression “curved portion located between said at least one vaporization portion and the condensation portion” is to be understood as follows

“The curved section is located between the respective (opposite) ends of the vaporization and condensation sections, along the main elongation direction (of the channels) of the heat pipe. The curved section may be located in an adiabatic intermediate zone, where the heat-carrying substance is partly liquid, partly vapor.

The angle (a hereafter) of the curved part, e.g. the elbow, may be between 45° and 95°, and/or between 60° and 90° to within 5°.

For instance, facing the cell(s) and successively, from one end of the channels to the other, the heat pipe has an upright portion, which may be substantially vertical, then is bent (aforementioned bend), then has a flat portion, e.g. substantially horizontal. The upright portion extends along the second or third side of the (each) cell concerned. The flat portion extends at least above the first side of the (each) cell concerned, e.g. it may be above the first side and/or below the fourth side opposite the first side. This covers L-, U- and C-shapes. With an L or C shape, this is considered from bottom to top. With an inverted U-shape, after the horizontal (flat) portion, the heat pipe continues with a second bend and then descends, presenting a second, substantially vertical, upright portion similar to the first upright portion. The (each) upright portion includes the vaporization part. The flat portion includes the condensation part. In other words, the heat pipe, and hence the channels, can be considered to be bent in the adiabatic zone between the successive vaporization and condensation sections.

In this text, the expressions “vertical” and “following the Earth's gravity field” are equivalent, and “horizontal” and “perpendicular to the Earth's gravity field” are equivalent.

The channels, which thus extend (each and together) between their ends, can communicate fluidically with each other, at one and/or other of these ends, thus at the lower end (43a hereinafter) of the vaporization section and at the upper end (45a hereinafter) of the condensation section.

The liquid phase of the heat transfer medium can then flow from one channel to another at the base of the heat pipe, as can the vapour phase at the end of the condensation section.

In addition to this, it is emphasized here that it has proved important:
that the edge of each cell is arranged opposite, along the vaporization part and the condensation part of the channels of the monoblock body, e.g. that the channels run parallel to the edge of each cell,
   vertically and then horizontally; and
   that the cathode terminal and/or the anode terminal of each cell is/are located opposite the vaporization part or the condensation part of the channels of the monoblock body.

As explained below, the above options may depend on the type of cell chosen: prismatic or pouch cell.

In any case, it was a decisive factor:
that not only (the principle of) a heat pipe is used for its thermal performance,
but that a maximum number of cells can be in heat exchange with a minimum number of heat pipes (in other words, blocks, or bodies, each integrating several channels as mentioned above), thus avoiding a loss of thermal efficiency (variation in efficiency between the blocks), problems of installation in the industrial phase (positioning, holding, mechanical connection between them), space requirements, pressure balancing and/or fluid level (the above-mentioned “heat-carrying substance”) in the channels,
but also that thermal control (ideally cooling; at the very least, slowing down the temperature rise) and mechanical protection of certain critical areas of the cells are ensured in the best possible way, via the heat pipe(s).

Placing the cathode and/or anode terminal of each cell opposite the vaporization or condensation part of the channels of the same monoblock body enables optimum thermal control of such a critical zone, both in terms of temperature variation and mechanical protection, as the angled shape of the heat pipe already favors this; and, placing the edge of each cell opposite the vaporization part and the condensation part of the channels of the monoblock body has made it possible to play on the number of cells that can be located along the same monoblock heat pipe body, so as to be thermally adjacent to it.

For instance, in connection with this last point, it is easy to ensure that, on the thermally controlled device, the body, with the series of channels it contains, faces—at the same time, via the same one-piece body—a number of said cells all adjacent to each other, and therefore successively arranged on said line, without any cell being bordered by this heat pipe body, thereby reducing the number of parts, and may avoid the disadvantages under 2) or 3) above.

It also proved useful to design the cold source as follows: so that it includes:
a cold plate capping (e.g. positioned opposite, just above) the condensation part of the channels of the same monoblock body, and crossed internally by circulation ducts,
a heat exchanger located at a distance from the cold plate, heat pipe and cells,
a heat-transfer fluid (liquid) in a sufficient quantity to enable its circulation in the cold plate circulation ducts and in the heat exchanger,
a circuit for the heat transfer fluid (liquid) to circulate between said cold plate and the heat exchanger.

Such a solution is thermally efficient, easy to manufacture and space-saving. What's more, it also contributes to the mechanical protection of the cell area where the anode and cathode terminals are located, on a prismatic, upright cell with its so-called “first side”-provided with the terminals-located on the upper face.

As is well known, a cold plate (or “cooling plate” or “liquid cold plate”) is a metal plate in which a heat-transfer fluid circulates. By heat exchange with a component to be cooled, the fluid (liquid) drains the heat from this component to the cold plate, all the way outside the component/cold plate system, to the remote heat exchanger. In other words, a cold plate is typically a liquid/air heat exchanger with fluid (liquid or gaseous) circulation. As noted, one option provides:
each cell is a prismatic, parallelepiped cell, and
that said anode terminal and cathode terminal of each cell are located on only the first side of the cell.

The benefits have already been mentioned.

In this case, said (at least one) vaporization part of the heat pipe may be located closer:
from the first, second or third side of the cell, or each cell, opposite it,
than is the condensation part of said heat pipe with respect to the cathode terminal or the anode terminal of the cell, or each cell, opposite it.

This is directly related to:
to the radius of the bend, or of each bend of the heat pipe concerned, and
in the interest of creating the best possible conditions for vaporizing the heat-carrying substance, all the more so if it's water-based.

The bend radius is therefore a compromise between:
fluidic continuity in the channels at this point,
a first minimum distance (for example, zero, to obtain support) from the vaporization part of the heat pipe facing (or against in case of contact) the first, second or third side of the cell (or each cell) located opposite the vaporization part (side without cathode and anode terminals),
a second distance, strictly greater than the first distance (projection of the cathode and anode terminals on the first side which carries them) but relatively limited (to limit thermal loss) with the condensation part, sufficient to allow condensation in the condensation part despite the proximity of the first side (and possibly of the cathode and anode terminals and their connectors to the other cells it carries in the case of prismatic cells).

This can be duplicated opposite, for the same cell, but with a different heat pipe, using the following solution.

In addition, the following solution can be adopted for the prismatic cell case:
that the aforementioned heat pipe defines a first heat pipe of which the said vaporization part of the channels extends upwards along:
on the (only) second side of the cell opposite it, or
of the respective second sides of the cells opposite it, and
that the controlled device further comprises a second heat pipe, conforming to said first heat pipe and with said vaporization portion of the channels extending along:
on the (only) third side of the cell opposite it, or
of the respective third sides of cells opposite it,
so that the respective bodies of the first and second heat pipes are partly located on either side of the facing cells, with their respective condensation portions directed towards each other.

The advantages already mentioned for a single-piece heat pipe placed in front of a slice (e.g. the narrowest sides) of one, and/or several, successive aligned cells, are amplified with the above solution.

Furthermore, “conformal” does not necessarily imply identical shapes, although it does imply that the heat pipe is defined by a one-piece body internally integrating a series of channels arranged side by side and containing a heat-carrying substance, as defined above.

A further performance aspect has been taken into account with the following consideration, according to which it is advisable that said condensation portion of the channels of the first heat pipe extend opposite:
only one of the anode and cathode terminals of the cell opposite it, or
one of the respective anode terminals and cathode terminals of the cells opposite it,
and that said condensation part of the channels of the second heat pipe extends opposite:
the other of the anode and cathode terminals of the cell opposite it, in case a), or
of the other respective anode terminals or cathode terminals of the cells opposite it, in case b).

In this way, the condensation section of a single heat pipe thermally controls, and mechanically protects, only one of the two lateral zones close to the narrowest sides of a cell or an uninterrupted succession of adjacent, aligned cells, while limiting overhangs.

Typically, on a prismatic cell, the anode terminal and cathode terminal are located laterally on the said “first side”, e.g. along the wafer, closer to the aforementioned second and third narrow sides respectively than to the central zone of this first side.

As a complement or explanation to the above, we can specify:
that said vaporization portion of the channels of the first heat pipe may extend upwards along the respective second sides of the cells located opposite it
that said vaporization portion of the channels of the second heat pipe may extend upwards along the respective third sides of the cells opposite it, and
that said respective condensation portions of the channels of the first and second heat pipes may extend flat, only close to the edges of the respective second and third sides of the cells facing them, respectively above only one of the series of respective anode terminals and cathode terminals of the facing cells.

In place of a prismatic cell, we propose:
each cell is a pouch cell, and
that said anode terminal and cathode terminal of each cell are located on
the cell's only second and third sides. In other words, if the second side carries the anode terminal, then the third side carries the cathode terminal and vice versa, the first side being free of any terminals.

In this case, it is advisable to locate at least one vaporization section of the heat pipe closer to:
of the cathode or anode terminal of the cell, or each cell, facing it,
than is the condensation part of said heat pipe opposite:
from the first, second or third side of the cell, or of each cell, facing it.

Adapted to the above context, what was previously stated in relation to the best vaporization conditions and the radius of curvature of (each) heat pipe bend still applies here.

In this case, the cathode or anode terminal of a cell will usefully rest against the vaporization part opposite the heat pipe in question.

And this can be duplicated opposite, for the same cell, with the following solution.

The following solution can also be adopted, still in the case of the pouch cell, namely that the heat pipe initially presented above defines a first heat pipe, the vaporization part of which will extend along the length of the pouch cell:
the (only) second side of the cell facing it, or
of the (only) respective second sides of the cells facing it,
the controlled device then further comprising a second heat pipe, conforming to said first heat pipe and with said vaporizing portion of the channels extending along:
the (only) third side of the cell facing it, or
the (only) respective third sides of facing cells,
so that the respective bodies of the first and second heat pipes are in part
located on either side of the facing cells, said respective condensation portions of the channels of the first and second heat pipes extending opposite each other:
on the (only) first side of the cell of the opposite cell, or of the (only) respective first sides of the facing cells.

The advantages of the “prismatic cell and first and second heat pipes face to face”.

To secure the electrical aspect between cell and heat pipe, the latter typically being metallic, it is necessary to interpose a layer of electrically insulating material between the heat pipe, or each heat pipe, and the opposite cell(s). This layer is not always illustrated in the figures, so as not to overload them.

Electrical insulator means having a volume electrical resistivity of the layer greater than 1E+6 Ohms·cm (106 Ohms·cm).

A problem addressed other than the essentially thermal aspect concerns the essentially mechanical aspect of the subject, without altering thermal performance. How to mechanically protect or maintain the heat pipe(s), without risk to the cells, is also a problem taken into account, with a reduced number of parts and in a way compatible with mass production and therefore a simple installation process.

It is therefore proposed:
that said thermally controlled device further comprises a housing including:
a base on which the cells and the or each heat pipe rest, and
upright walls, fixed to the bottom and completely enclosing the cells and the or each heat pipe,
so that the or each heat pipe is clamped between:
the opposite cell(s) and
the one opposite,
the or each vaporizing part is thus pressed against the opposite cell(s).

Although only two such parallel walls could be used, the advantages include:
otherwise, a protective, supportive peripheral belt is easily created,
that induced support of the heat pipe(s) results in favorable vaporization of the heat-carrying substance in the channels, thus creating a thermal/mechanical synergy,
that no additional parts other than the upright walls on a base are required, such simple clamping of the heat pipe(s) being quick to achieve in mass production, via convenient access from above, with simple engagement in the same direction first of the cells, then of the heat pipes,
that heat pipe tilting is avoided, despite the intrinsic instability of a heat pipe with an overhang, typically an L-shaped heat pipe,
that fastening the base and upright walls together is simple, for example by screwing, simple disassembly for cell access and removal remains possible.

In addition, the foregoing makes it possible to provide, considering the existence of a plurality of heat pipes, each conforming to one of the foregoing:
the cold plate is:
one-piece and laid flat, or
in several parts laid flat side by side,
that the cold plate completely covers all the heat pipes and all the cells, the latter being in thermal contact with the said condensation parts, and
that the cold plate is in thermal contact with said condensing parts and is fixed with the bottom or upright walls,
in this way:
that all cells and heat pipes, as a whole, are tightly packed
between the bottom and the cold plate, and
a gasketed enclosure is formed around the cells and heat pipes.

This makes it easy to provide blocking and mechanical protection in two directions (vertically and horizontally), with thermal synergy for both vaporization and condensation. The cold plate can simply be placed/fixed on top, after the heat pipes.

Like the heat pipe(s), the cold plate or even the cover will be thermally conductive, at least on the side facing the heat pipe(s).

Thermally conductive has the usual meaning 2≥50 W/mK.

The present solution also relates to an electric or hybrid vehicle comprising:
at least one electric motor to move it, and
the thermally controlled device described above, the electric motor being powered by the electric battery to which it is connected.

### BRIEF DESCRIPTION OF THE FIGURES

FIG. 1 illustrates the components used to operate an electric or hybrid vehicle.

FIG. 2 shows an exploded view of a single heat pipe facing the wafers of a series of (prismatic) battery cells aligned along a single line.

FIG. 3 shows the same view as FIG. 2, but in operating condition, with the heat pipe (its vaporization section) pressed against the cell edges, towards one of the second and third sides of the cells.

FIG. 4 shows the same view as FIG. 2, but with 3 separate, aligned heat pipes defined by three independent bodies, each facing a series of prismatic cell slices.

FIG. 5 shows the same view as FIG. 4, but with two parallel rows of cells facing the edges of which are two single heat pipes, located on either side of these rows.

FIG. 6 shows a variant of FIGS. 2 and 4, but with 3 separate, aligned heat pipes, defined by three independent bodies, each facing a series of prismatic cell wafers.

FIG. 7 shows the same view as FIG. 6, but in an operational situation, like FIG. 3 or FIG. 24.

FIG. 8 shows a variant like FIG. 6, but with 2×3 heat pipes aligned, distinct from each other and located on either side of the two rows of prismatic cells.

FIG. 9 shows the same view as FIG. 8, but in an operational situation.

FIG. 10 shows the same view as FIG. 9, but with more prismatic cells and separate heat pipes.

FIG. 11 shows the same view as FIG. 7, with a cold plate in operation, above the prismatic cells and heat pipes.

FIG. 12 shows the same view as FIG. 11, with a horizontal cross-section of the cold plate, showing its interior and the ducts running through it.

FIG. 13 shows the same view as FIG. 11, but with more prismatic cells and separate heat pipes, and not a single cold plate, but a modular one made up of several parts side by side.

FIG. 14 shows the same view as FIG. 12, but applied to the situation shown in FIG. 13.

FIG. 15 shows the same view as FIG. 13, but with a single cold plate above all the prismatic cells and heat pipes.

FIG. 16 shows the same view as FIG. 15, with a horizontal section of the cold plate, as in FIG. 14.

FIG. 17 shows an enclosure for cells and heat pipes, with upright walls topped by a closing cover including a cold plate.

FIG. 18 shows the same view as FIG. 17, with cells and heat pipes, with a horizontal section of the cold plate, as in FIG. 14.

FIG. 19 shows the same view as FIG. 18, with the cells and heat pipes in the housing.

FIG. 20 shows a variant of FIG. 19, based on the solution shown in FIG. 13, with modular cold plates.

FIG. 21 shows the same view as FIG. 20, showing all the cells in the housing.

FIG. 22 shows all the elements required to ensure that the cold source is at the right temperature for condensation in the heat pipe(s).

FIG. 23 shows the same view as FIG. 22, with more detail on the housing walls, attached at the bottom and, between them, at the corners.

FIG. 24 shows another configuration for cell and heat pipe arrangement.

FIG. 25 shows an electrically insulating coating to be interposed between the cells and any metal heat pipe, and the electrical connectors covering the terminals of the prismatic cells, here above them (facing the first sides of the cells).

FIG. 26 are the electrical connectors covering the pocket cell terminals, here on either side of them (facing the second and third sides of the cells).

FIG. 27 shows another configuration of cells and heat pipes: two parallel rows of cells and U-shaped heat pipes on top of these cells.

FIG. 28 shows the same view as FIG. 27, but with 3 U-shaped heat pipes aligned around the two parallel rows of cells.

FIG. 29 shows a view of a single cold plate, above the heat pipes and the cells they border,

FIG. 30 shows the same view as FIG. 29, with a horizontal section of the cold plate, as in FIG. 14.

FIG. 31 shows an exploded view of a single angled heat pipe facing the wafers of a series of battery “pocket” cells aligned along a single line.

FIG. 32 shows the same view as FIG. 31, but in an operational situation, with the heat pipe (its vaporization part) pressed towards the cell edges, facing one of the two respective lateral series of terminals (cathode or anode) projecting from the second and third sides of the cells.

FIG. 33 shows the same view as FIG. 31, but with two angled heat pipes located:
on either side of a series of aligned electric “pocket” cells,
facing the said wafers, and therefore facing the second and third sides of the cells provided with terminals (cathode or anode).

FIG. 34 shows the same view as FIG. 33, but in an operational situation, with the heat pipes (their vaporizing parts) pressed against the terminals on the cell wafers.

FIG. 35 shows the same view as FIG. 34, but with several series of angled pocket heat pipes in operation, whose vaporizing sections laterally border several rows of pocket cells, facing the respective lateral series of terminals projecting from the second and third sides of the cells.

FIG. 36 shows the same view as FIG. 34, but with two heat pipes, still facing each other, but C-shaped, not L-shaped as in FIGS. 33 to 35.

FIG. 37 shows a view of a modular (multi-part) cold plate, above heat pipes and pocket cells.

FIG. 38 shows the same view as FIG. 37, with a horizontal section of the cold plate parts, as in FIG. 14.

FIG. 39 shows a side view of a single longitudinally bent heat pipe (body), following arrow I in FIG. 2.

FIG. 40 shows the same view as FIG. 36, but with a (single) U-shaped heat pipe, applied laterally to the second and third sides of prismatic cells, with free space above the terminals each projecting from the first side of each cell.

FIG. 41 shows the same view as FIG. 41, but with a line of pocket cells, the heat pipe again being applied laterally towards the second and third sides of the cells (e.g. towards their terminals), again with this free space above the first side of each cell.

FIG. 42 shows another configuration, with prismatic cells and a combination of L- and U-shaped heat pipes laterally bordering one or two rows of cells.

FIG. 43 illustrates another configuration, with two (single) L-shaped heat pipes laterally bordering aligned cells, the two heat pipes being joined at the ends of their respective condensation sections by a junction that connects them mechanically and makes them integral.

FIG. 44 shows the same view as FIG. 36, but with two parallel rows of prismatic cells, the two C-shaped heat pipes facing each other in opposite directions.

FIG. 45 shows the same view as FIG. 36, but with a row of prismatic cells bordered by two lateral heat pipes, L-shaped and C-shaped (inverted) respectively, which face each other laterally at their vaporizing and condensing ends.

FIG. 46 shows a set of cells and heat pipes to be placed and clamped in a gasketed housing, under a cover and a cold plate.

FIG. 47 shows a similar implementation of FIG. 24 to FIG. 36, but with two parallel rows of prismatic cells, the two C-shaped heat pipes facing each other in opposite directions.

FIG. 48 shows a partial cross-section of a heat pipe in the direction of main elongation (of the channels), which can therefore be considered to correspond to cross-section II-II or III-III of FIG. 39, in the direction of channel staggering.

FIG. 49 shows an assembly similar to that of FIG. 24, comprising two parallel rows of prismatic cells and three inverted L-shaped heat pipes, and including two clamping means for mounting in a housing.

FIG. 50 shows a group of assemblies from FIG. 49 being mounted in a housing and on top of which are attached a thermal interface material (also known by the acronym TIM for “Thermal Interface Material”), a seal, a thermally conductive closure plate and a plurality of cold plates of one or more heat exchangers (not shown) intended to be in thermal contact with the condensing parts of the heat pipes via the closure plate and the thermal interface material.

FIG. 51 shows an assembly similar to that shown in FIG. 50, but in which the cover plate incorporates the cold plates of one or more heat exchangers (not shown).

FIG. 52 shows another assembly similar to that of FIG. 50.

### DETAILED DESCRIPTION

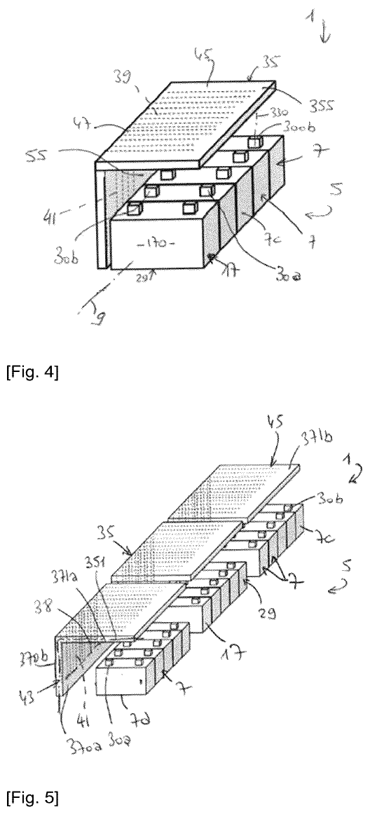

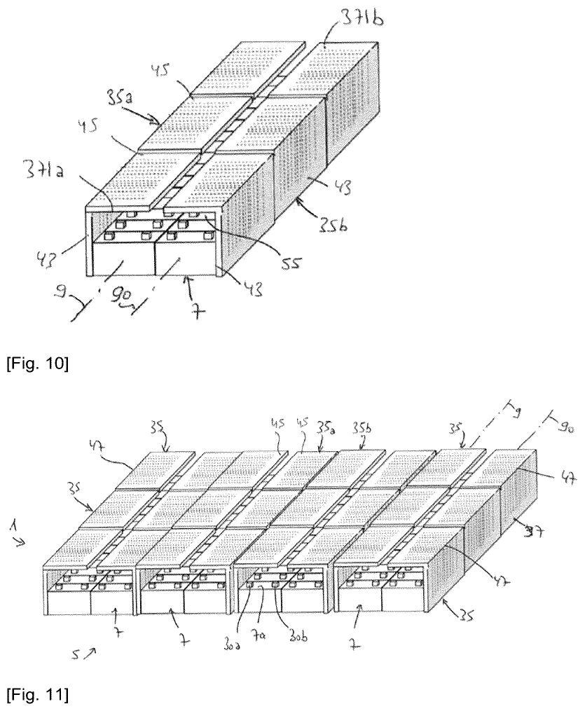

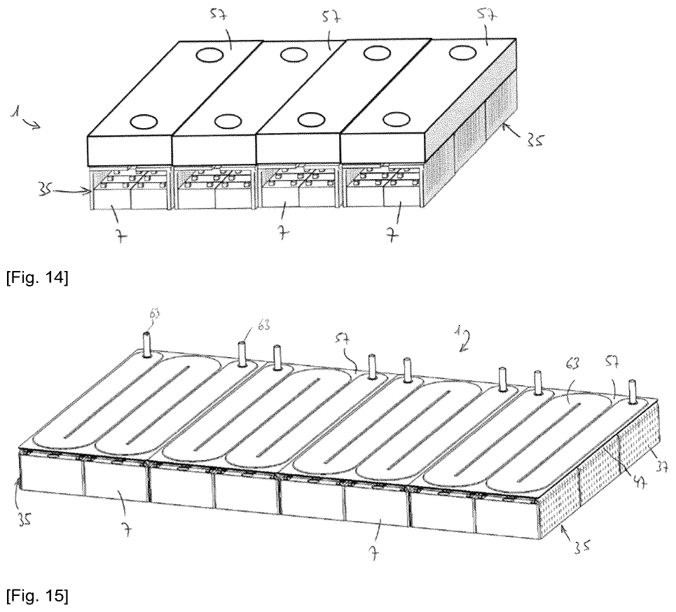

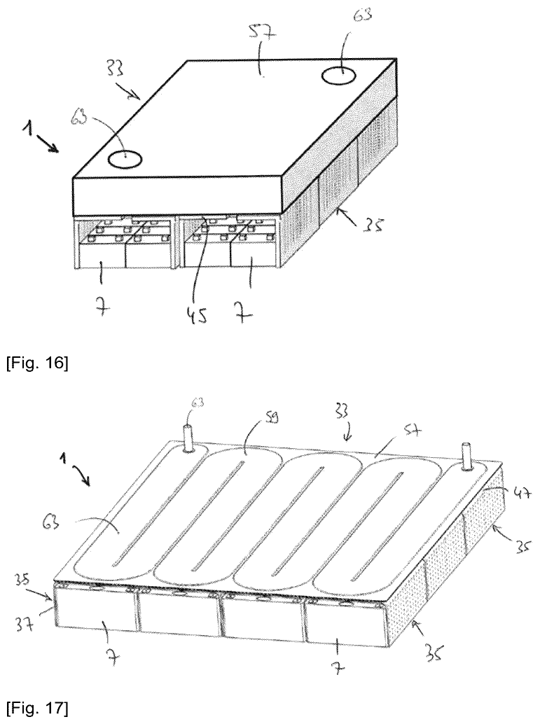

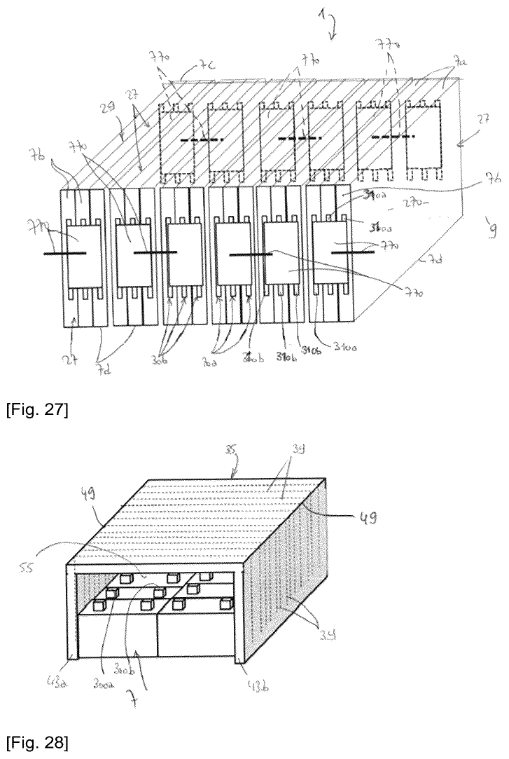

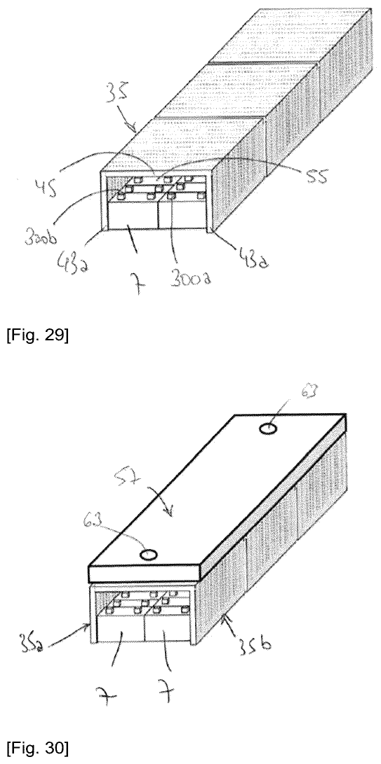

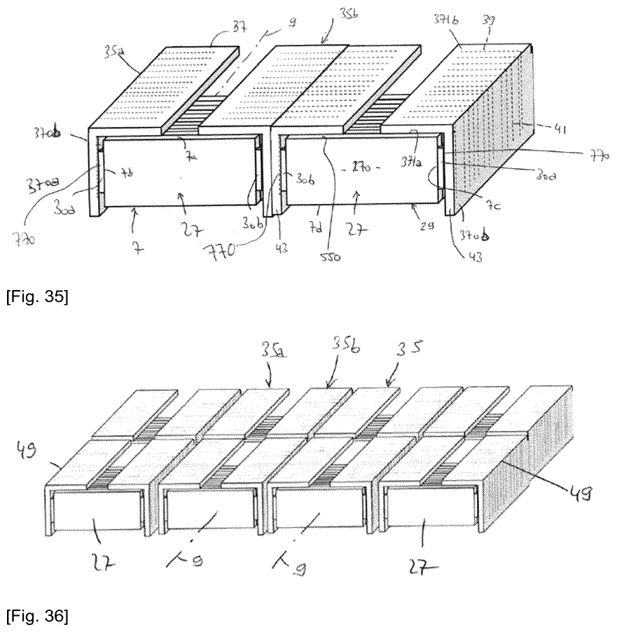

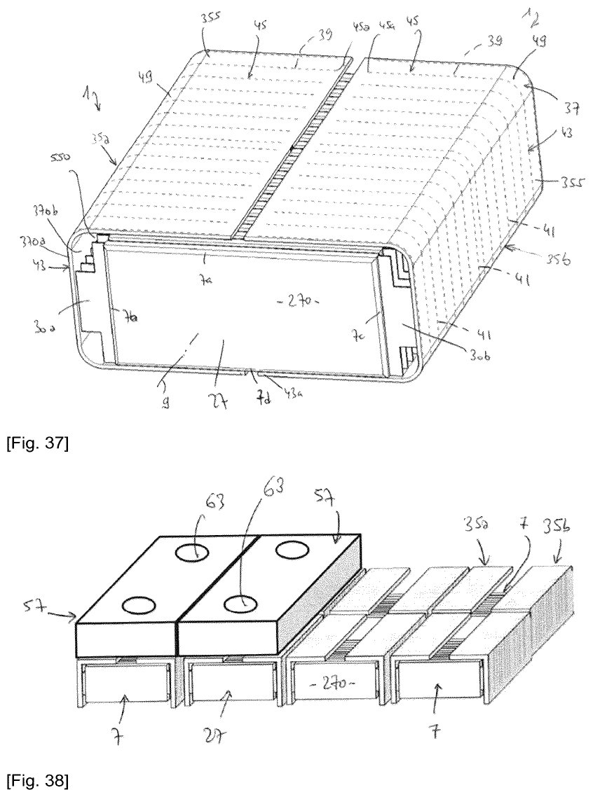

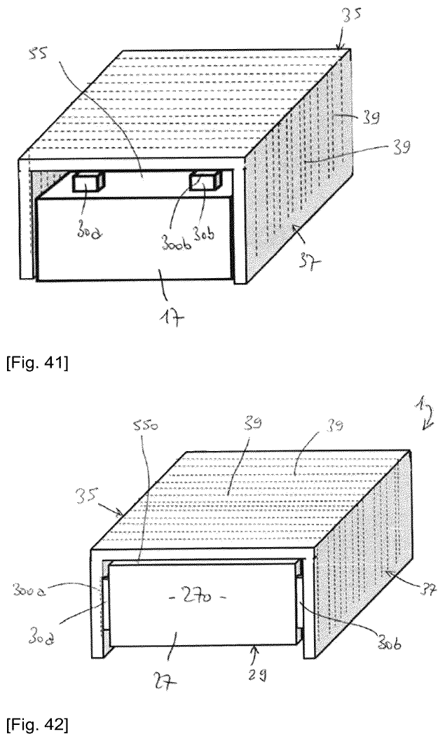

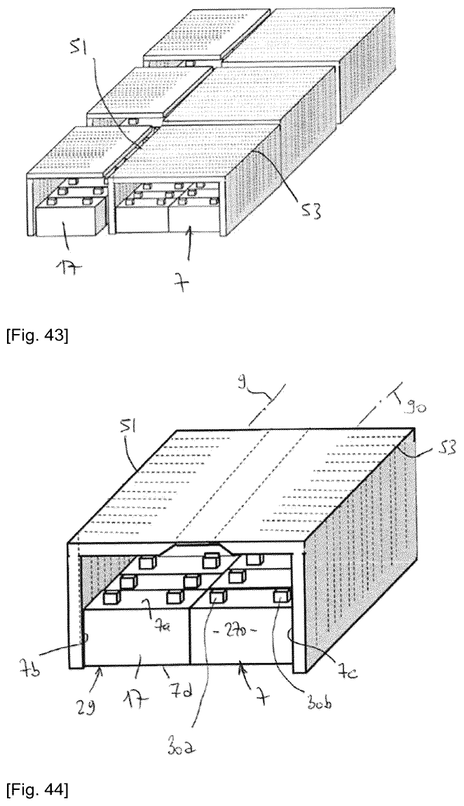

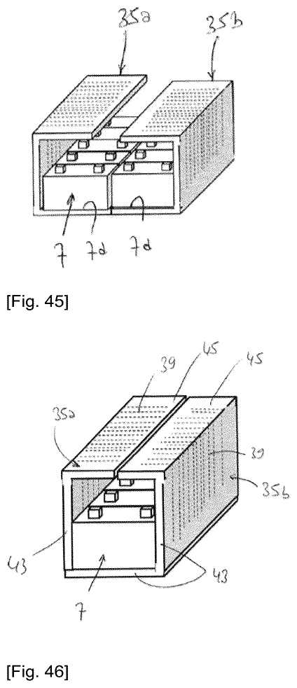

FIGS. 1 to 52 show a thermally controlled device 1 for storing electrical energy in chemical form for a vehicle 3.

What is described below refers to observations made in the device's (functional) position of use.

Vehicle 3 is an electric or hybrid vehicle. As shown in FIG. 1, the vehicle 3 is driven by the electromotive force of one or more electric motors 11, powered by a storage battery 5 connected to the motor 11 and to an electric generator 13. In addition to the electric motor 11 and battery 5, the vehicle 3 includes a computer/inverter 19, a DC/DC converter 21, a transmission 23 and a differential 25.

The battery 5 supplies electrical energy which is stored in it. It can be recharged via an electrical socket 15 connected to it via the DC/DC converter 21.

The device 1 is a set of elements enabling the battery 5 to be temperature-controlled, or even mechanically protected, so that it does not overheat, at least when it is operating; such as when it is being recharged with electrical energy.

Device 1 thus comprises the electric battery 5, which includes a plurality of electric cells 7, also known as accumulators, arranged parallel to one another along at least one line 9.

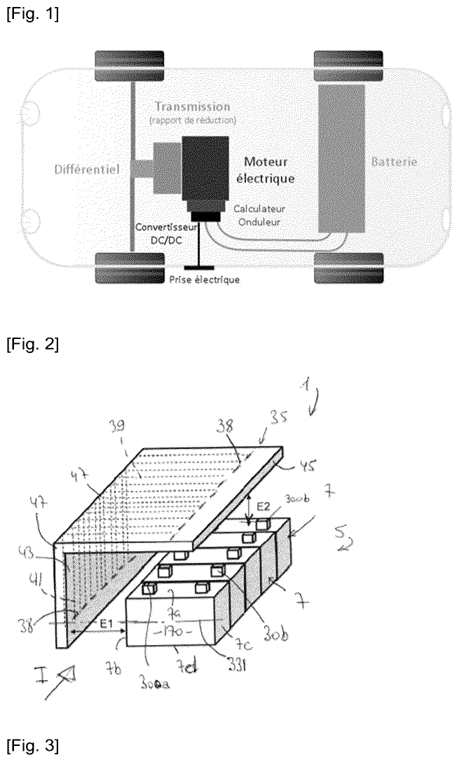

As shown in FIGS. 2, 3-7, 25, 26, 31-34, 36, 43, each cell 7 has a first side 7a, a second side 7b and a third side 7c. The second side 7b and third side 7c are parallel to each other and transverse to the first side 7a. Each cell, which may be prismatic 17 or pouch 27, has an edge 29 that runs all the way around the cell, where it is narrowest and thinnest. In both cases, each cell 7, 17, 27 is substantially parallelepipedic, with four successive sides, 7a, 7b, 7d, 7c, adjacent and transverse. On the thinner edge 29, the first and fourth sides 7a, 7d are the longest; these are the horizontal sides, respectively top and bottom. The second and third sides 7b, 7c are the shortest; these are typically the vertical, lateral sides, left and right respectively, cell viewed from the front, on one of its two largest opposite faces 7e.

As known:
a prismatic cell 17 is a cell with an external envelope or body of a rectangular parallelepiped 170 where the first side 7a, second side 7b and third side 7c are located, and
a pouch cell 27 has an external envelope or body 270 where the first side 7a, second side 7b and third side 7c are also located. A pocket cell 27 is so called because of its bag or pouch format.

Each cell 7, 17, 27 has a cathode terminal 30a and an anode terminal 30b, which together or separately are located on at least one of the first, second and third sides 7a, 7b, 7c. Along edge 29, on prismatic cell 17, cathode terminal 30a and anode terminal 30b are present only on first side 7a (top side). On the pocket cell 27, the cathode 30a and anode 30b terminals are on the second side 7b and the other on the third side 7c (lateral sides). Each terminal 30a 30b protrudes from the side 7a, 7b, 7c on which it is located.

As shown for example in FIGS. 11, 20-23, 29, 30, 37, 38, device 1 further comprises a heat exchange device 31 comprising:
a cold source 33, and
at least one heat pipe 35 capable of heat exchange with the cells 7, at least one/some of them, and the cold source 33.

As shown in all FIGS. 2 to 38 and 40 to 45, and for example FIGS. 2, 3, 5-7, 33, 34, 36, 39, the heat pipe 35 and cell(s) 7 face each other.

The heat pipe 35 operates by gravity. A single heat pipe 35 is considered to be an element or plate 355 defined by a single, one-piece body 37, internally integrating a series of channels 39 arranged side by side, and containing a heat-carrying substance 41. In this way, the heat pipe 35, and hence the channels 39, is erected for operation. The body 37 and thus the channels 39 have longitudinally, both together and individually, at least one vaporization section 43 and one condensation section 45 in fluid connection, through which the heat transfer medium can flow. In the vaporization section 43, the heat-carrying substance 41 can be heated up to the point of vaporization by calories from at least one of the following cells 7. At the condensation section 45, the heat-carrying substance 41 can be cooled by heat exchange with the cold source 33, until it condenses.

The “heat-carrying substance (or fluid)” 41 defines a two-phase working fluid. It may be trans-1-chloro-3,3,3-trifluoropropene (known as R1233ZDE).

The one-piece body 37 forms a sealed enclosure around the channels 39.

For instance, the channels 39 communicate fluidically with each other via one or more transverse volumes 38:
at their base—(lower) end 43a of (the vaporizing part)—and/or
at their apex end 45a or longitudinally opposite-free end of (part of) condensation 45.

In this way, fluid 41 (communicating vessel principle) and/or pressure (for instance, in the vapour phase) can be balanced at these ends.

These communications 38 are transverse to the main elongation direction 351 of the heat pipe, or at least of its internal channels 39; see, for example, FIGS. 2,6,33,39 (the communications 38 have not been shown systematically on the figures, so as not to overload them).

In the one-piece body 37, apart from the possible communication points 38, the channels 39 are separated by partitions 390.

As shown in all FIGS. 2 to 45, e.g. FIGS. 2,3,33: To enable the top of the cells 7 under consideration to be covered, the body 37 is angled. The channels 39, and therefore the body 37, each have a curved portion 47 located between said vaporization end 43a under consideration and the opposite end 45a of the condensation portion 45.

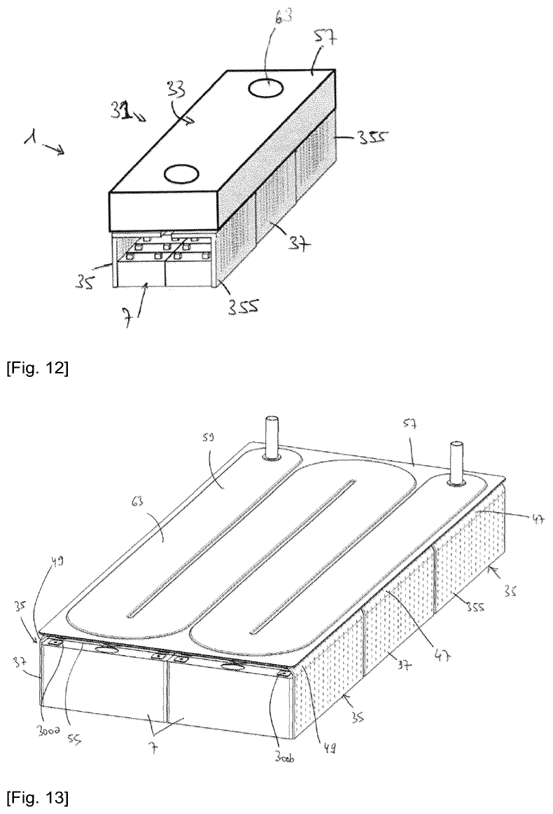

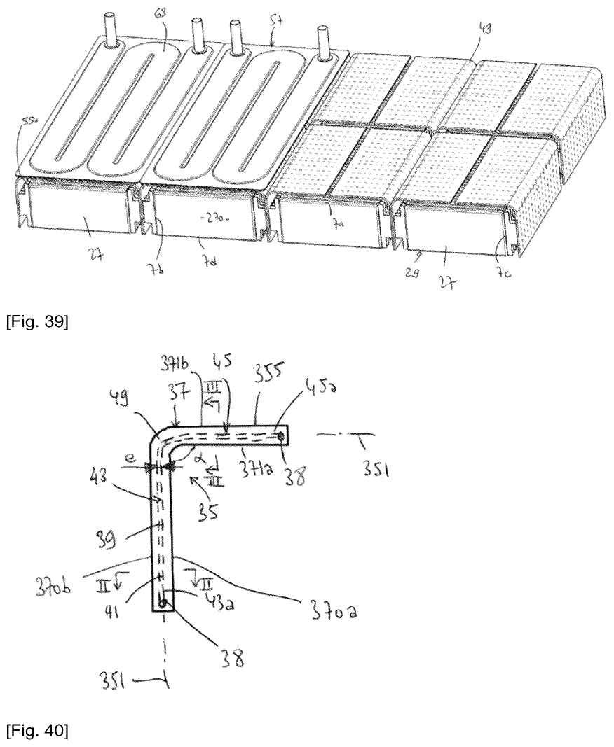

In this way, the main elongation direction e 351 is angled. For instance, the heat pipe 35, e.g. body 37 and channels 39, can be designed with a single bend 49 (L-shaped) or two bends 51, 53 (U-shaped). Longitudinally, each elbow 51, 53 is interposed between an upper central condensation section 45, which may be horizontal, and one of two lower vaporization sections 43, each of which may be vertical. Elbow 49, which is common to all channels 39, is L-shaped and lies between the upper condensation section 45, which is horizontal, and the lower vaporization section 43, which is vertical. Any bend 49, 51, 53 is defined by a rounding. The bend has a limiting radius of curvature which may maintain the channels at a constant cross-section over their length(s) between their two opposite free ends 43a, 45a, all the more so as a metallic heat pipe 35 may be used, and as a priori vertical and horizontal vaporization part 43 and condensation part 45 are sought, respectively (see, for example, FIGS. 12, 14, 36, 39). On the figures, the angles are sharp, as they are diagrams; FIG. 39, on the other hand, is quite illustrative (angle α).

As a compromise between thermal and mechanical constraints, and as shown in several figures, and virtually all except FIG. 1, the one-piece body 37 can usefully take the form of a curved flat plate, favouring the presence of a series of parallel internal channels 39, following one another according to the dimension of the plate, which extends along the line or two lines 9, 90, cells.

As shown in FIGS. 4, 31, 32 and 34, for example, the one-piece body 37 has the following external features:

along the vaporization section 43, surfaces, respectively internal 370a (concave side of the elbow) and external 370b (convex side of the elbow) and along vaporization section 45, inner surface 371a (concave side of bend) and outer surface 371b (convex side of bend).

The inner surface 370a is directed towards the cells and is pressed against them, precisely towards the second and/or third side, along their respective slices 29.

The inner 370a and/or outer 370b surfaces may be flat in the sense that, over more than 30% of their surfaces:
the inner surface, 370a, can serve as a bearing surface for pressing against the facing cells 7, 17, 27,
the outer surface, 370b, can serve as a support surface for one of the facing upright walls 69 (see below), for support towards said cells.

As shown on almost all figures, except FIGS. 1 and 39, and for example FIGS. 4, 6, 32, for an optimized thermal efficiency, see a mechanical protection effect, and a solution with heat pipe(s) with optimized positioning/sizing:

the edge 29 of each cell 7 is located along the vaporization part 43 and the condensation part 45 of the channels of the one-piece body in question, and the cathode terminal 30a and/or the anode terminal 30b of each cell is located opposite the vaporization part or the condensation part of the internal channels 45 of the monoblock body.

In other words, as can be seen from FIGS. 6,7, considering a single heat pipe 35 and at least one prismatic cell 17, both in the position or state of use, the aforementioned “opposite” situation involves all or part of the following:

The two terminals, cathode 30a and anode 30b, of the cell project from the (only) first side 7a of body 170.

Each cathode terminal 30a and anode terminal 30b extends (rises) from the first side 7a of the body 170 to an end face, known as the free face 300a or 300b.

The free face 300a of the cathode terminal and/or 300b of the anode terminal extends opposite the condensation portion 45 of the heat pipe body.

The free face 300a of the cathode terminal and/or 300b of the anode terminal is capped, above it, by the condensation portion 45 of the heat pipe body facing it.

The free face 300a of the cathode terminal and/or 300b of the anode terminal extends above, and plumb with, the condensation portion 45 of the heat pipe body facing it.

The direction 330 along which the cathode terminal 30a or the anode terminal 30b projects from the first side 7a of the body 170 and the condensation portion 45 of the heat pipe body facing it intersect;

The position of use is that in which the inner surface 370a of the vaporizing part 43 of the heat pipe is located at a first distance E1 as small as possible (such as zero to obtain thermal contact against the second and/or third side of the cell) from the second side of the cell(s) located opposite it.

With regard to the latter, “contact against the second or third side” means direct thermal contact or indirect thermal contact via terminals or connectors between terminals of different cells.

If there are several heat pipes to be considered, in position of use:
the vaporization parts 43 of the lateral heat pipes 35a, 35b are applied against the second side 7b and third side 7c of the prismatic cell bodies respectively,
at a distance E1 (see below) as small as possible, for instance, substantially equal to zero, along a direction 331 passing through the second side 7b and third side 7c of a cell 17 and through the vaporization portion 43 of a
single body 37 of the heat pipe,
the same heat pipe (body 37) faces several aligned cells.

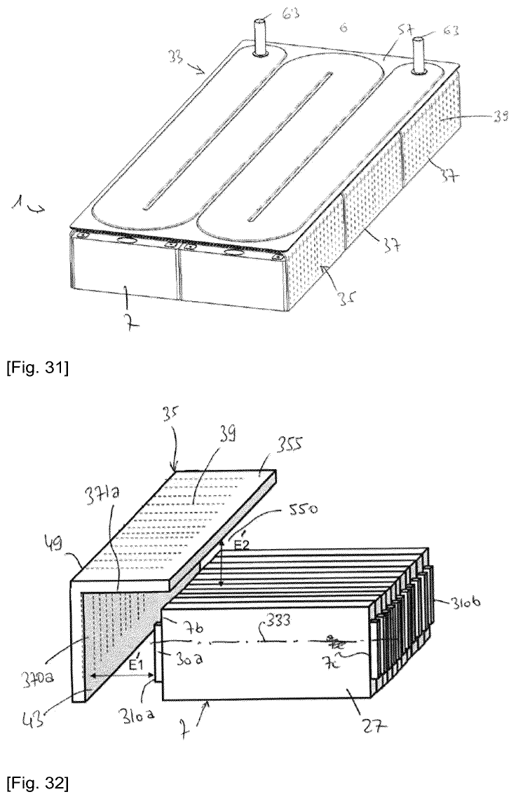

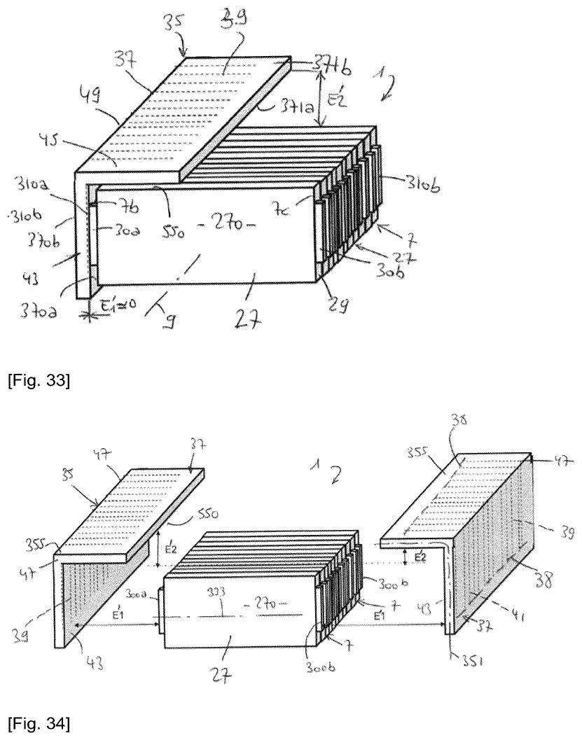

In the case of pocket cell 27, as shown in FIGS. 31, 32, considering a single heat pipe 35, in position or state of use, the aforementioned “opposite” situation implies all or part of the following:

The cell's two terminals, cathode 30a and anode 30b, project respectively from the second side 7b and the third side 7c of the body 270, in the same direction 333.

In a direction 333, each cathode terminal 30a and anode terminal 30b extends from the relevant side 7b or 7c of the body to an end, known as the free end, 310a and 310b respectively.

The free end 310a of the cathode terminal or 310b of the anode terminal extends opposite the vaporization portion 43 of the heat pipe body.

The direction(s) 333 and the condensation portion 43 of the heat pipe body facing the cell(s) 27 intersect.

The position of use is that in which the (inner surface 370a of the) vaporization part 43 of the heat pipe is located as close as possible to the second side or third side of the cell(s) located opposite it (E′1, along direction 333, as low as possible; see below).

If there are several heat pipes to be considered, in position of use:
the vaporization parts 43 of the lateral heat pipes 35a, 35b are applied to the terminals of the second side 7b and third side 7c of the pocket cell bodies respectively,
the same heat pipe (body 37) faces several aligned cells, via one of its terminals 30a or 30b, but also its first side 7a.

In this way, it will be possible, on any cell 7, 17, 27, for both terminals, cathode 30a and anode 30b, to be thermally controlled in the best possible way. In this respect, the above-mentioned rounded elbow shape will be all the more effective in the following cases 1.1), 1.2). If the cell type is prismatic, 17.

In this case, the (inner surface 370a of the or each) vaporizing part 43 is located:
closer (distance E1) to the side of the cell, or each cell, opposite (this applies to the second side 7b and/or the third side 7c, depending on whether the heat pipe is C-shaped, U-shaped or L-shaped),
than is the condensation section 45 with respect to the cathode terminal 30a or the anode terminal 30b of the or each opposite cell (distance E2).

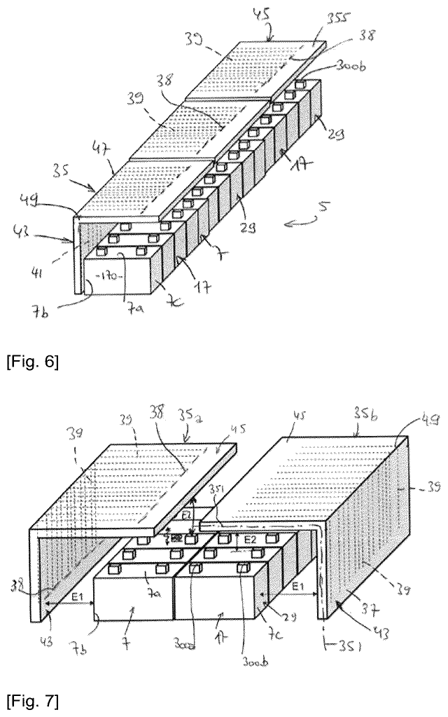

In other words, as in FIGS. 6, 7, distances E1 and E2 are identified such that E1<E2, with E1=0.

E1 is:
the distance between the second side 7b of one, such as 171a, of the aligned cells 17 and the inner surface 370a of the heat pipe, such as 35a (hereinafter sometimes referred to as the “first heat pipe”), located opposite this second side; or,
the distance between the third side 7c of the same cell 171a and the inner surface 370a of another heat pipe, such as 35b (hereinafter sometimes referred to as the “second heat pipe”), located opposite this third side 7c.

The direction in which E1 extends may be perpendicular to the second side 7b and/or third side 7c and inner surface(s) 370a.

E2 is the distance between the inner surface 371a of the condensation part and the free face 300a and/or 300b.

The direction in which E2 extends may be perpendicular to the first side 7a and to the inner surface 371a. Thus:
the or each spraying part 43 may usefully rest against the side of the cell, or each cell, opposite,
while a gap 55 will exist just above cathode terminal 30a and/or anode terminal 30b.

This favors optimized vaporization (E1=0), a solution deemed more thermally efficient than contact between condensation part 45 and cathode terminal 30a or anode terminal 30b, especially since:
keep lateral (horizontal) dimensions to a minimum, reducing the battery's footprint,
the free space 55 can then serve as a technical passage (cables, etc.) and/or receive connectors 77 which can be slid between them and the condensation part 45,
a cold plate (such as 57; see below) can be, typically flat, in thermal contact with external surface 371b of condensation part(s) 45, whether there are one or more heat pipes, said free space between cells and condensation part 45 allowing homogenization of the heat to be evacuated,
different (heights of) prismatic cells can be combined,
a metal plate can be used as a heat pipe, despite the aforementioned constraint of limiting the radius of curvature: a part of vaporization 43 in blocked support, e.g. vertical (see the wedge that can easily be provided), effectively ensures an L-shaped heat pipe, despite the overhang and with the creation of the useful space 55 above the terminal in question; ditto with a U or C-shaped heat pipe.

If the cell is a pocket type 27:

In this case, the or each spraying part 43 is located:
closer to the cathode terminal 30a or the anode terminal of the cell, or each cell, opposite (distance E′1),
than is the condensation section 45 (distance E′2) from the opposite side of the cell, or each cell (this applies to the first-upper, often horizontal-side 7a, regardless of whether the heat pipe is C- or L-shaped).

In fact, here again, E′1<E′2, as in FIGS. 31-33; and/or, E′1=0, unless we consider the presence of probable connectors 770 projecting slightly from terminals 30a, 30b.

In other words, we identify distances E′1 and E′2 such that E′1<E′2, with E′1=0.

E′1 is:
with respect to a second side 7b, the distance between the free end(s) 310a and/or 310b of one, such as 271a, of the aligned cells 27 and the inner surface 370a of the heat pipe, such as 35a (hereinafter referred to as the “first heat pipe”), located opposite this second side; or else,
for a third side 7b, the distance between the third side 7c of the same cell 171a and the inner surface 370a of another heat pipe, such as 35b (hereinafter referred to as “second heat pipe”), located opposite this third side 7c.

The direction in which E′1 extends may be perpendicular to the second side 7b and/or third side 7c and inner surface(s) 370a.

E′2 is the distance between the inner surface 371a of the condensing section and the first side 7a.

The direction in which E′2 extends may be perpendicular to the first side 7a and to the inner surface 371a.

Thus:
the or each vaporization part 43 can be pressed towards the said second side 7b and/or third side 7c of the cell, or of each cell, towards the cathode terminal 30a and/or the anode terminal 30b opposite,
while a space 550 will exist just above the first side 7a.

Some of the advantages already mentioned are reproduced.

Typically, E1/E′1 will be a horizontal distance and E2/E′2 a vertical distance.

From cases 1.1), 1.2) above and with the same projected advantages, it can be defined, for any type of cells that may be used, that the said at least one vaporization part, such as 43, will be usefully located closer:
the first, second or third side (such as 7a, 7b, 7c) of the or each cell, such as 7, 17, 27, opposite, or
of the cathode terminal or anode terminal, such as 30a 30b, of the or each opposite cell,
than is the condensation part, such as 45, opposite:
in case a1), the cathode terminal or the anode terminal of the cell, or of each cell, opposite the cathode terminal or the anode terminal.
in case a2), of the first, second or third side (such as 7a, 7b, 7c) of the or each opposite cell.

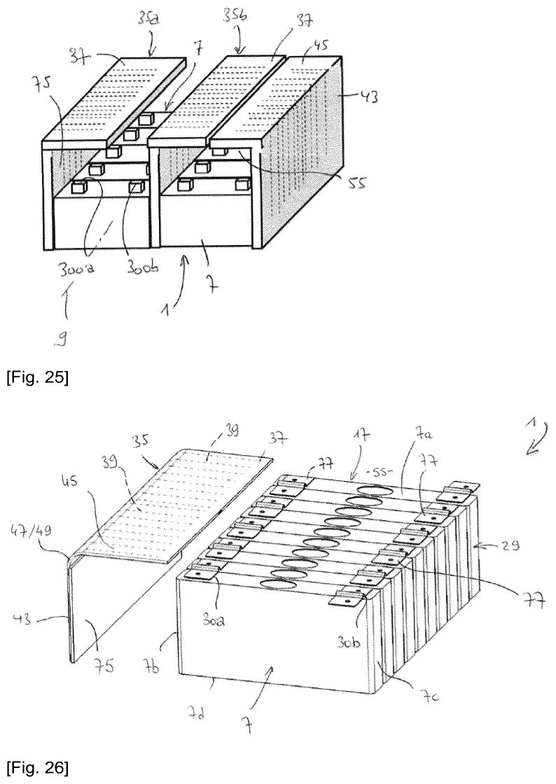

In case 1.1) or with prismatic cells 17, space 55 (height E2) will be used to place connectors 77 (tabs or bus bars) linking cells 7, 17 individually or in groups to each other and/or to the existing electrical network. Several cathode and/or anode terminals are linked together by a connector 77, as shown in FIG. 25. Cells can thus be connected in series or in parallel, or in a mixed circuit with the characteristics of both a series circuit and a parallel circuit. A single connector 77 may cover, and act as electrical contact for, a group of several (at least two) cathode 30a or anode 30b terminals of successive, adjacent cells 17, and thus be located in space 55, or even extend laterally beyond it.

As illustrated in FIG. 33 or 34, in case 1.2) or with pocket cells such as 27, the space 550 (height E′2) may depend on the presence of “lateral” connectors 770 (see, for example, FIG. 26), functionally identical to connectors 77 and thus enabling series, parallel or mixed connections. Acting as an electrical contact for a group of cathode 30a or anode 30b terminals of successive and adjacent cells 27, connector 770 will therefore be pressed against them. Each connector 770 is fixed against the free end 310a or 310b of the terminals 30a or 30b of adjacent, parallel cells of line 9 or 90, which it electrically connects together and from which it therefore protrudes. The heat pipe 35 is then pressed against the opposite cell(s) by this or each connector 770; see FIG. 34 (elsewhere the connectors 770 have not been shown/represented, to avoid overloading). In this way, the rounding of the elbow 49, 51, 53 and the size of the connectors 770 can be adjusted to best suit the height E′2, without significantly altering the energy performance of the vaporization section 43.

The above confirms that, in all cases, the or each vaporizing part 43 can usefully be placed against the cell, or each cell, facing it, whether this support is direct or indirect, as in the case of pocket cells, via connectors 770.

Regardless of the type of cell, the cold source 33 may also be used, as shown in whole or in part in FIGS. 11-23, for example:
a cold plate 57, a priori made of metal, placed opposite, a priori flat, just above the condensation part 45 of the same one-piece body 37 (e.g. channels 39) and crossed internally by circulation ducts 59,
a heat exchanger 61 located at a distance from the cold plate, heat pipe and cells,
a heat-transfer liquid 63 in a quantity sufficient to enable it to circulate in the cold plate's internal ducts 59, and
a circuit 65 for circulating heat-transfer fluid 63 between ducts 59 and heat exchanger 61.

A pump 62 in circuit 65 circulates the heat transfer liquid.

63. And an expansion vessel 64 between heat exchanger 61 and liquid inlet 63 can handle any overflow.

The heat exchanger 61 is used to adapt the temperature of the heat-transfer liquid 63, a priori to cool it. The outlet temperature of liquid 63 from cold plate 57 will be higher than its inlet temperature, which may be below 30° C.

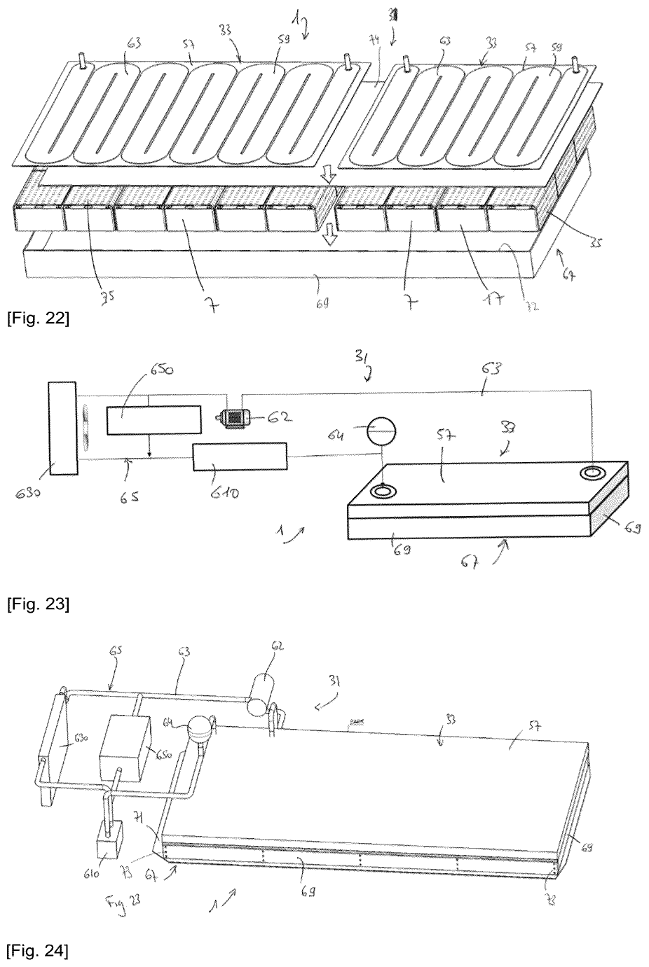

As illustrated for example in FIGS. 22 and 23, heat exchanger 61 may comprise a heat exchanger (e.g. liquid/liquid) 610 in series with a heat exchanger (e.g. liquid/liquid) 610 in series with a heat exchanger (e.g. liquid/liquid).

630 radiator or 650 heater, which can be connected in parallel.

Given the number of cells, such as 7, 17, 27, in a single battery 5, the thermally controlled device 1 will usefully comprise, as already understood, a plurality of heat pipes 9, each in accordance with the above.

Furthermore, as illustrated in FIGS. 11-21, the cold plate 57 can be either a single piece, or made in several parts side by side, and placed flat opposite, or even resting on, the respective condensation parts 45.

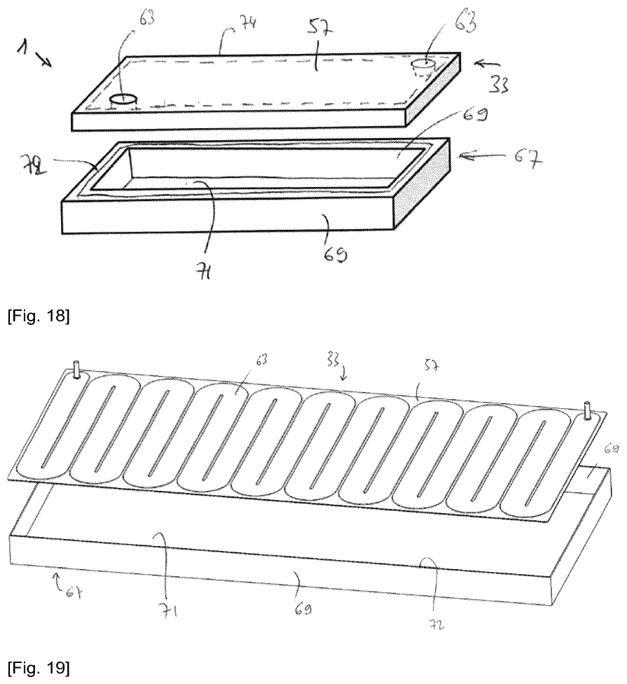

For mechanical/thermal synergy, it is advisable to follow the principle illustrated in FIGS. 17, 18, 22 and 23, and therefore to block the cells and heat pipes 35, horizontally and vertically, in a simple but uncompromising way. As shown in FIG. 46, the device 1 is fitted with a housing 67 comprising:
a base 71 on which the cells and the or each heat pipe 35, 35a or 35b rest, and
clamping means 46 configured to clamp each heat pipe against the second side and/or third side of the opposing cell(s), so that the or each vaporizing part is pressed against the opposing cell(s).

The housing further comprises upright walls 69, fixed to the base 71 and enclosing the cells 7 and the heat pipe(s), which are to be clamped against the upright walls 69, via the clamping means 46 arranged between the heat pipe(s) and the upright walls 69.

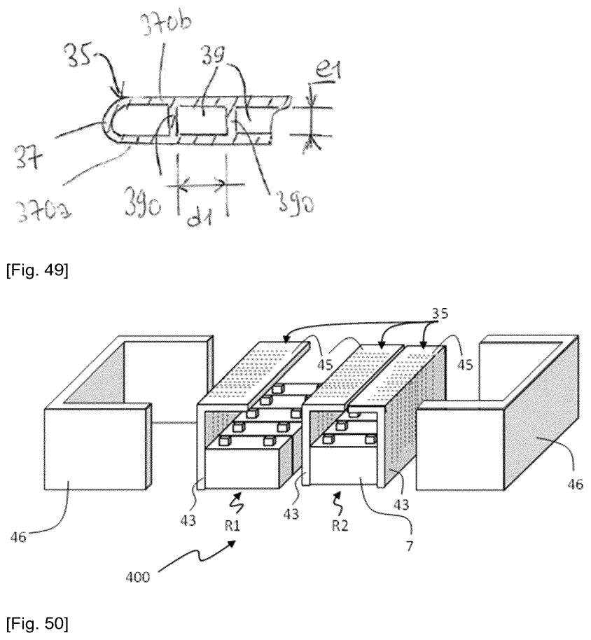

For example, the clamping means consists of two C-pieces (see also FIGS. 49 to 53) which surround the heat pipes at their vaporization section, so as to force them against the cells when the assembly is
inserted between the upright walls 69. In other words, the clamping means 46 act as a clamping spacer between the upright walls of the housing and the vaporizing portions of the heat pipes. Alternatively, the clamping means may comprise a spring bearing against the vaporizing portion of the heat pipes and against either a spacer or the upright walls 69 themselves, so as to constrain the vaporizing portions of the heat pipes against the second side and/or third side of the facing cell(s).

Thus, there will be at least two parallel upright walls 69 arranged on either side of a series of cells 7 and one or more heat pipes 35 which are to be clamped against the cells 7.

The upright walls 69 may completely surround all the cells 7 and the heat pipe(s) concerned. In this way, the or each heat pipe will be clamped between the cell(s), such as 7, 17, 27, located on the inside face and the one of the upright walls 69 located on the outside face, with the or each vaporization part 43 thus trapped between the facing cell(s) and the upright walls 69. The upright walls 69 then define a perimeter ring.

We also recommend:
all heat pipes 35 and cells 7 are completely covered by the cold plate 57, and
cold plate 57 with the bottom 71 or the upright walls 69:
all cells and heat pipes are clamped between the bottom 71 and the cold plate 57, and
a housing 67 closed by a gasket 72 is formed around the cells and heat pipes.

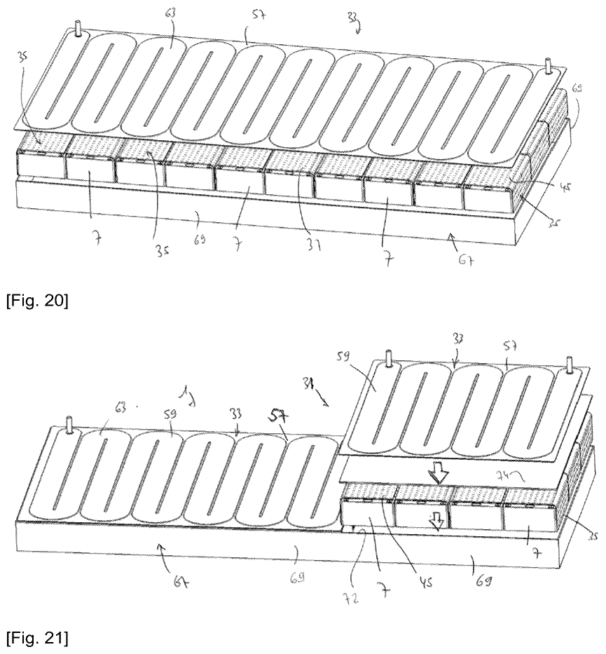

The 70 housing thus comprises the 71 base, 69 walls and:
2.1) or the cold plate 57, in a battery pack enclosure cover version, in which the cold plate 57 also forms a cover and is then typically thicker, and can be provided with walls
forming a dropped edge; see example FIG. 46,
2.2) or a cover 74 for closing the housing 72 from above, the cold plate 57 being fixed (welded) to the cover 74, either from above, as in FIG. 20 or 21, or from below, as in FIG. 17.

In all cases, a fastening 76 between the cover and the walls 69 may be provided, for example by screwing, as shown in FIG. 46.

And in cases 2.1) and 2.2), the cold plate 57 would be separate from (e.g. not integral with) the heat pipes 35.

To seal the housing 67 in a watertight (liquid-tight) manner, a gasket 72 is interposed between the cover (cold plate 57 or cover 74) and the walls 69; see FIG. 17 or 46, for example.

An advantage of solution 2.1), or 2.2) with the cold plate 57 option above the cover 74 and fixed (welded) to it, is that the cold plate 57 is then outside the housing 67, which is closed by the cover/walls 69 superposition and sealed by the gasket 72. This prevents any leakage of heat transfer fluid 63 into the housing. In assumption 2.2), the closed housing 67 and the cold plate 57 can even be produced independently, and the cold plate 57 can then be attached to the cover 74.

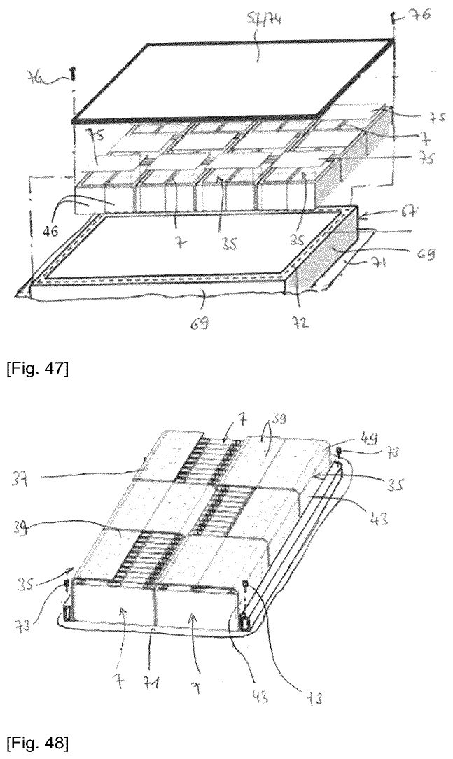

To facilitate assembly/disassembly/recovery of forces, the upright walls 69 can be designed as (for example, four) parallelepiped hollow tubes, which can be individually straight, secured by screws 73 to the base 71 and in pairs to the outer corners; see, for example, FIG. 23 or FIG. 47.

Furthermore, in the case of a metallic (electrically conductive) design and given the desired support between heat pipe(s) 35 and cell(s), such as 7, 17, 27, a layer 75 of electrically insulating material is interposed between the heat pipe, or each heat pipe, and the cell(s). As shown, for example, in FIG. 25 or 46, this may be in the form of an electrically insulating coating 75a covering (applied against) at least the inner face 370a of the heat pipe facing one or more cells; at least the second side 7b and/or the third side 7c mentioned above are involved, due to the desired lateral support of the heat pipe/cell(s).

Rather than providing one heat pipe 35 per cell 7, e.g. facing a single cell 7, it is also recommended that the same one-piece body 37—and therefore the series of parallel channels 39 it encloses—faces (the slices 29 of) several cells 7, all adjacent to each other and in succession; see virtually all figures except 1 and 39. Advantages: fewer heat pipes, high mechanical strength (for instance, condensation section 45), good stability (cantilever compensation), standardization of heat exchanges, this:
all the more so with the (two) transverse communication volumes 38 provided between the channels 39, and
if the heat pipes face only sides of the 29 edge of any 5 cell.

As already noted, it will certainly be appropriate to provide for the use of a series of heat pipes 35, 35a, 35b. It is then recommended that they be made/arranged in groups of two, as illustrated for example in FIGS. 6-17, 24, 32, 33.

By way of illustration, the following describes two set-ups that may be for this purpose.

In the first assembly, as illustrated for example in FIGS. 6-10, 34, 36, there are associated:
a first heat pipe 35a, with said vaporization part 43 of channels 39 extending upwards along:
the second side 7b of the opposite cell, or
the respective second sides 7b of the facing cells,
and a second heat pipe 35b, conforming to said first heat pipe 35a and having said vaporization portion 43 of channels 39 extending along:
the third side 7c of the opposite cell, or
respective third sides of facing cells.

Thus, the respective bodies 37 of the first and second heat pipes 35a, 35b are partly located on opposite sides of cells of the same line, such as 9 which face them, with their respective condensation portions 45 which can be directed:
one towards the other (as illustrated, for example, in FIGS. 6, 33, 36),
or, on the contrary, by moving away from each other (as shown, for example, in FIG. 24).

With advantages such as the above, two further considerations are developed below:
for prismatic cells (case 3.1), then
for pocket cells (case 3.2),
in the case where only two heat pipes are considered, such as 35a, 35b with single or multiple elbow(s), such as 49, 51, 53:

### 3.1) Case of Prismatic Cells, Such as 17:

In this case, the condensation part 45 of the channels 39 of the first heat pipe 35a extends opposite:
3.1a) of only one of the anode and cathode terminals 30a, 30b of the cell facing them, or
3.1b) of one of the anode terminals and cathode terminals 30a, 30b of the cells facing them,
and said condensation part 45 of the channels 39 of the second heat pipe 35b extends opposite:
3.1c) of the other of the anode terminal and cathode terminal 30a, 30b of the cell facing them, in case 3.1a), or
3.1d) of the other respective anode terminals or cathode terminals 30a, 30b of the cells facing them, in case 3.1b).

In this way, the hot areas of these terminals that may be in closest proximity to the condensing parts 45, in many variants of heat pipe positions and/or shapes.

### 3.2) Case of Pocket Cells, Such as 27:

In this case, said vaporization portion 43 of the channels of the first heat pipe 35a is then arranged to extend upright along:
the second side 7b of the facing cell 27, or
of the respective second sides 7b of the facing cells 27,
while the vaporization part 45 of the channels 39 of the second heat pipe 35b extends along:
the third side 7c of the cell facing it, or
respective third sides 7c of facing cells 27.

In this way, the respective one-piece bodies 37 of the first and second heat pipes 35a, 35b will be partly located on opposite sides of the cells facing them, and the said respective condensation portions 45 of the channels 39 of these first and second heat pipes will extend opposite:
the first side 7a of the opposite cell, or
of the respective first sides 7a of the facing cells 27,
any such first side 7a of cell 27 being devoid of cathode terminal 30a or anode terminal 30b.

Note that the above-mentioned “opposite” situation involves what has already been specified, in conjunction with either prismatic cells or pocket cells.

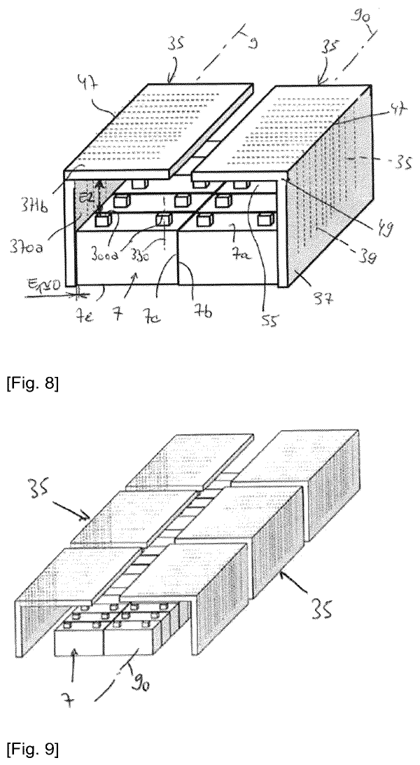

In connection with the above, it should also be noted that, as illustrated for example in FIGS. 9, 24, 32, 35, 43, the following may be provided:
arrange cells, such as 7, 17, 27, in one or more parallel lines (or rows), such as the two lines 9, 90,
to arrange the heat pipes, such as 35a, 35b, themselves in one or more parallel and successive lines (or rows), along, as the case may be:
a single line of cells, such as line 9 or 90,
two successive parallel lines of cells,
on either side of a single cell line,
on either side of two successive parallel lines of cells, such as
than the two lines 9, 90; e.g. with or without the interposition of an intermediate heat pipe line between two successive lines 9, 90.

As will have been noted, in addition to being L-shaped or hoop-shaped, the or each heat pipe 35, 35a, 35b can therefore be C-shaped, as illustrated for example in FIGS. 36, 44.

With a C-shape, the vaporization section 43 extends below the cell(s) 7 in question; fourth side 7d. By extending the length of the heat pipe, one advantage may be to enhance evaporator performance.

With C-shaped heat pipe(s), the cells rest indirectly on the bottom 71; the heat pipe rests directly, via its lower leg. With L-shaped or U-shaped (inverted) heat pipes and cells can be supported directly.

For any heat pipe, e.g. any heat exchanger 35, 35a, 35b mentioned above, it can be chosen that in the same heat pipe (body 37), as shown in FIG. 48:
each channel 39 is adapted as follows:

It has a hydraulic diameter of 1.9 millimeters,
it has a cross-section, considered perpendicularly to the direction 351 of main elongation, whose dimensions are 0.046 cm²;
fluid 41 is trans-1-chloro-3,3,3-trifluoropropene (known as R1233ZDE), R290 or NOVEC™ 649
the thickness el of each channel 39, in the direction joining the inner (370a or 371a) and outer (370b or 371b) surfaces of the heat pipe, is between 0.8 mm and 5 mm, and/or between 2 mm and 3 mm; see FIG. 39,
the distance dl between two successive 390 partitions, e.g. the width of each 39 channel, may be 1.9 millimeters.

These dimensions enable hybrid operation of gravity heat pipes, e.g. between
the condensate from the 41 substance flows by gravity to the 43 evaporator. However, the formation of the condensate could have been carried out in a hybrid manner.

FIGS. 49 to 52 illustrate an example of a process for assembling a battery obtained by assembling several modules, each module comprising a set of cells and heat pipes arranged according to the present disclosure.

The 400 assembly is similar to that shown in FIG. 24. It comprises two parallel rows R1 and R2 of prismatic cells 7 and three inverted L-shaped heat pipes 35: one heat pipe 35 per row and an additional common heat pipe whose vaporization portion 43 is common to both rows of cells, e.g. it is in contact with a second/third edge of the cells in each row R1 and R2. The condensation portions 45 of the three heat pipes are arranged above the first edge (the upper edge in the figure) of the cells 7 and at a distance from, e.g. not in contact with, said first edge.

The 400 assembly also includes two clamping means 46 for mounting in a housing. The clamping means (46) will encircle the evaporation areas (43) of the heat pipes (35) located on the outside of the assembly and, when they rest against the upright walls of the housing, will clamp the heat pipes (35) against the cells, thereby promoting heat exchange and evaporation of the phase-change material present in the heat pipes.

As shown in FIG. 50, a plurality of assemblies 400 from FIG. 49 are grouped together and being assembled in a housing 501.

Above each assembly 400, a thin layer 502 of thermal interface material (also known by the acronym TIM for “Thermal Interface Material”) can be provided to ensure, despite any surface imperfections, heat transfer from the condensation section 45 of the heat pipes 35 to the cold plate(s) 503 of one or more heat exchangers (not shown in full). If the surface is perfectly flat, the TIM layer is not necessary.

The housing 501 is sealed by a thermally conductive closure plate 504 in contact with the TIM layers 502 and a peripheral seal 505 designed to cooperate with a seal groove 506 carried by the housing 501, the cold plate(s) being arranged in thermal contact above the closure plate 504.

In other words, in the position of use, the cold plate(s) are in thermal contact with the condensation portions 45 of the heat pipes 35 via the closure plate 504 and the thermal interface material 502.

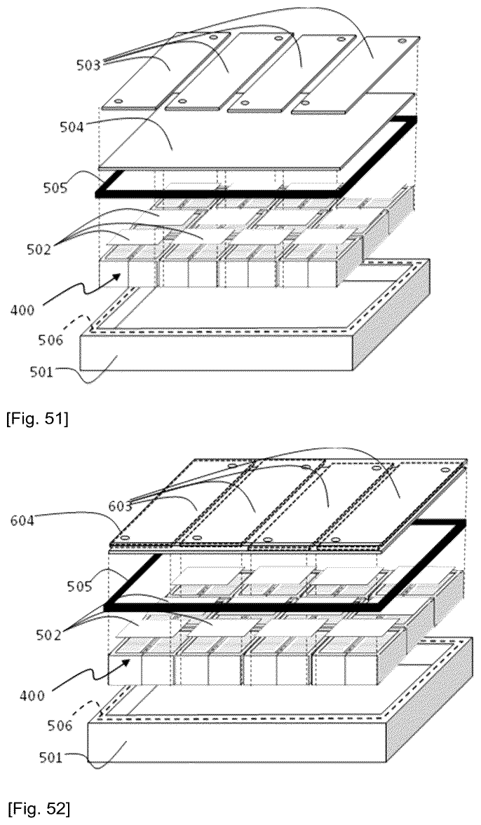

FIGS. 51 and 52 illustrate an alternative embodiment and process, for example in which the closure plate 604 directly incorporates within it the cold plates (shown dotted) of one or more heat exchangers (not shown in their entirety).

Of course, there can be one or more cold plates. Similarly, each 400 assembly may be longer, e.g. the rows longer and comprising more cells. In this case, several heat pipes 35 can be provided side by side along the length of the rows.

These arrangements can also be adapted to pocket cells. In this case, the vaporization portions 43 of the heat pipes 35 will be in contact with the cathode and anode terminals or electrical connectors linking the anode terminals of several cells on the one hand, and the cathode terminals of said cells on the other.

Other types of clamping means can also be provided, as long as they ensure close, constrained thermal contact between the vaporization part of the heat pipes and the electrical cells.

In another representation, a thermally controlled device for storing electrical energy in chemical form for a vehicle is provided, the controlled device comprising an electrical battery comprising a plurality of electrical cells arranged parallel to one another in a line, each cell having a first side, a second side and a third side, the second side and third side being parallel to one another and transverse to the first side, characterized in that wherein the thermally controlled device further comprises a heat exchange device comprising one or more of: a cold source, and a heat pipe for heat exchange with the cells and the cold source, the heat pipe being defined by a one-piece body internally integrating a series of channels arranged side by side, and containing a heat-carrying substance, each cell having an edge where the cell is thinnest and where the first, second and third sides of the cell are located, each cell having a cathode terminal and an anode terminal located on at least one of the first, second and third sides of the cell, the channels have at least one vaporization section where the heat-carrying substance can be heated to vaporization by calories from at least one of the cells, and a condensation section where the heat-carrying substance can be cooled to condensation by heat exchange with the cold source, the body being angled, so that the channels each have at least one curved portion located between the at least one vaporization portion and the condensation portion, the edge of each cell being located along the vaporization part and the condensation part of the channels of the monoblock body, the cathode terminal and/or the anode terminal of each cell being located opposite the vaporization part or the condensation part of the channels of the monoblock body. The thermally controlled device may have the body, with the series of channels therein, facing a plurality of said cells all adjacent to each other in succession, and/or the cold source may comprise: a cold plate containing circulation channels, a heat exchanger located at a distance from the cold plate, heat pipe and cells, a heat-transfer fluid in a quantity sufficient to allow it to circulate in the cold plate's circulation channels and in the heat exchanger, and a circuit for the heat transfer fluid to circulate between said cold plate and the heat exchanger.

1. A thermally controlled device for storing electrical energy in chemical form for a vehicle, the controlled device comprising an electrical battery comprising a plurality of electrical cells arranged parallel to each other along a line, each cell having an edge where the cell is thinnest and where a first side, a second side and a third side are located, the second side and third side being parallel to each other and transverse to the first side, each cell comprising a cathode terminal and an anode terminal located on a single side or on two different sides of the cell,
wherein the thermally controlled device further comprises a first heat exchange device comprising:
a heat pipe capable of heat exchange with the cells and a cold source of at least one second heat exchange device,
the heat pipe being defined by a one-piece body internally integrating a series of channels arranged side by side and containing a heat-carrying substance,
the channels have at least one vaporization section where the heat-carrying substance can be heated to vaporization by calories from at least one of the cells, and a condensation section where the heat-carrying substance can be cooled to condensation by heat exchange with the cold source of the second heat exchange device,
the body being angled, so that the channels each have at least one curved portion located between said at least one vaporization portion and the condensation portion,
the heat pipe being so arranged that:
the edge of each cell is located along the vaporization part and the condensation part of the channels of the monoblock body,
the cathode terminal and/or the anode terminal of each cell are located opposite the vaporization part or the condensation part of the channels of the monoblock body; and
the condensation section is located at a higher elevation than the vaporization section with respect to gravity.

2. The thermally controlled device according to claim 1, wherein the vaporizing part faces at a first distance (E1) from the second side and/or the third side or from the terminals carried by said second side and/or third side, while the condensing part faces at a second distance (E2) from the first side or from the terminals carried by said first side, the second distance (E2) being strictly greater than the first distance (E1).

3. The thermally controlled device according to claim 2, wherein the first distance (E1) is zero so that the vaporizing part is in thermal contact against the second and/or third side of the cell or terminals carried by said second and/or third side.

4. The thermally controlled device according to claim 1, wherein the body, with the series of channels therein, faces the first side and at least one of the second side and third side of a plurality of said cells all adjacent to each other, which follow each other.

5. The thermally controlled device according to claim 1, wherein the second heat exchange device comprises:
the cold source, comprising a cold plate with circulation ducts,
a heat exchanger with ambient air, located at a distance from the cold plate, heat pipe and cells,
a heat-transfer fluid in sufficient quantity for circulation
in the cold plate ducts and in the heat exchanger, and
a circuit for the heat transfer fluid to circulate between the cold plate ducts and the heat exchanger.

6. The thermally controlled device according to claim 1, wherein:
each cell is a prismatic, parallelepiped cell, and
said anode terminal and cathode terminal of each cell are located on the first side of the cell only.

7. The thermally controlled device of claim 4, wherein said at least one vaporization portion is located closer to the second and/or third opposing side of the or each cell than is the condensation portion to the cathode and anode terminals carried by the first opposing side of each cell to the condensation portion.

8. The thermally controlled device according to claim 6, wherein said heat pipe defines a first heat pipe of which said vaporizing portion of the channels extends upright along:
the second side of the opposite cell, or
the respective second sides of the facing cells,
the controlled device further comprising a second heat pipe, conforming to said first heat pipe and with said vaporizing portion of the channels extending along:
the third side of the opposite cell, or
respective third sides of facing cells,
so that the respective bodies of the first and second heat pipes are partly located on either side of the facing cells, with their respective condensing portions directed towards or away from each other.

9. The thermally controlled device of claim 8, wherein:
said condensation part of the channels of the first heat pipe extends opposite:
a) only one of the anode terminal and cathode terminal of the opposite cell, or
b) one of the respective anode terminals and cathode terminals of the opposite cells,
and said condensation part of the channels of the second heat pipe extends opposite:
c) the other of the anode terminal and cathode terminal of the opposite cell in case a), or
d) of the other respective anode terminals or cathode terminals of the opposite cells, in case b).

10. The thermally controlled device according to claim 1, wherein:
each cell is a pocket cell, and
said anode terminal and cathode terminal of each cell are located on only the second and third sides of the cell.

11. The thermally controlled device of claim 10, wherein said at least one vaporizing portion is located closer to:
of the cathode terminal or anode terminal of the cell, or each cell, opposite,
than the opposite condensation part:
on the first, second or third side of the cell, or
of each opposite cell.

12. The thermally controlled device according to claim 10, wherein said heat pipe defines a first heat pipe of which said vaporizing portion of the channels extends upright along:
the second side of the opposite cell, or
the respective second sides of the facing cells,
the controlled device further comprises a second heat pipe, conforming to said
first heat pipe and with said vaporizing portion of the channels extending along:
the third side of the opposite cell, or
respective third sides of facing cells,
so that the respective bodies of the first and second heat pipes are partly located on either side of the facing cells, said respective condensation portions of the channels of the first and second heat pipes extending opposite one another:
the first side of the cell opposite, or
of the respective first sides of the facing cells.

13. The thermally controlled device according to claim 1, wherein a layer of electrically insulating material is interposed between the or each heat pipe and the facing cell or cells.

14. The thermally controlled device according to claim 1, further comprising a housing in which a plurality of said heat pipes are arranged, the housing comprising:
a bottom on which the cells and the plurality of said heat pipes rest, and
clamping means configured to clamp each heat pipe against the second side and/or third side of the opposing cell(s), so that the or each vaporizing part is pressed against the opposing cell(s).

15. The thermally controlled device according to claim 14, wherein the pressing means comprises upright walls, attached to the bottom and surrounding the cells and the plurality of said heat pipes, as a whole.

16. The thermally controlled device according to claim 5:
in which the cold plate:
is a single piece or made up of several parts laid flat side by side,
is arranged in thermal contact with said condensing parts,
completely covers all heat pipes and cells as a whole, and
is attached to the housing, so
that all the cells and heat pipes, as a whole, are clamped between the housing and the cold plate, with said condensation parts interposed between them.

17. The thermally controlled device according to claim 1, wherein the or each heat pipe is a gravity heat pipe operating in thermosyphon, pulsed or hybrid mode.

18. An electric or hybrid vehicle comprising:
at least one electric motor to move it, and
the thermally controlled device according to claim 1, the electric motor being powered by the electric battery to which it is connected.

19. A thermally controlled device for storing electrical energy in chemical form for a vehicle, the controlled device comprising an electrical battery comprising a plurality of electrical cells, each cell comprising a cathode terminal and an anode terminal located on a single side or on two different sides of the cell, wherein the thermally controlled device further comprises a first heat exchange device comprising a heat pipe capable of heat exchange with the cells and a cold source of at least one second heat exchange device, the heat pipe being defined by a body internally integrating a series of channels arranged side by side and containing a heat-carrying substance.

20. The thermally controlled device of claim 19, wherein the channels have at least one vaporization section where the heat-carrying substance can be heated to vaporization by calories from at least one of the cells, and/or a condensation section where the heat-carrying substance can be cooled to condensation by heat exchange with the cold source of the second heat exchange device.
